(19) United States
(12) Patent Application Publication
(10) Pub. No.: US 2009/0048970 A1
(43) Pub. Date: Feb. 19, 2009

(54) Approval and Issuance of a Financial Card

(76) Inventor: Michael A. Muscato, Winter Park, FL (US)

Correspondence Address: MERCHANT & GOULD PC, P.O. BOX 2903, MINNEAPOLIS, MN, 55402-0903, US

(21) Appl. No.: 12/028,393

(22) Filed: Feb. 8, 2008

Related U.S. Application Data
(60) Provisional application No. 60/889,167, filed on Feb. 9, 2007.

(51) Int. Cl. G06Q 20/00; G06Q 40/00

(52) U.S. Cl. 705/40

(57) ABSTRACT

A method comprising issuing, at a virtual credit card issuer, a virtual credit card to an entity and debiting a monetary amount from a credit card account associated with a credit card issued by a financial institution that has extended credit to the entity. The method also comprises crediting the monetary amount to a virtual credit card account associated with the virtual credit card. The virtual credit card issuer would receive a request for payment directly from a merchant who accepted a credit card number of the virtual credit card as a form of payment from the entity. The request for payment when a monetary amount specified by the request for payment is less than or equal to the monetary amount credited to the virtual credit card account associated with the virtual credit card would be honored.

### CROSS REFERENCE TO RELATED APPLICATION

This application claims benefit of U.S. Provisional Application Ser. No. 60/889,167 filed Feb. 9, 2007, which application is incorporated herein by reference.

### BACKGROUND OF THE INVENTION

### Field of the Invention

This invention relates generally to a financial card.

### SUMMARY OF THE INVENTION & DESCRIPTION OF EMBODIMENTS

The disclosure provided in the following pages describe examples of some embodiments of the invention. The designs, figure, and description are non-limiting examples of some embodiments of the invention. For example, the description of the Gkard system relates only to a description of some embodiments of the invention. Other embodiments of the Gkard system may or may not include the features disclosed herein. Moreover, disclosed advantages and benefits may apply to only some embodiments of the invention, and should not be used to limit the invention.

In an embodiment, a virtual financial card is used to pay for online goods and services. The financial card is associated with a credit card for billing purposes, but is independent of the credit card for transactions. For example, the virtual financial card is loaded with a specific value from the credit card account for a one-time online purchase. The virtual card number is not reusable for additional purchases beyond the initial value. This provides additional security for the credit card account holder.

### DESCRIPTION OF THE DRAWINGS

FIG. 1 shows an example process for consumers to buy products and services with GKARDS.

FIG. 2 shows an example process for GKARD purchase and load.

### DETAILED DESCRIPTION

### Introduction

The purpose of this document is to provide a business and solution case overview of implementation of a Visa Electron/Signature Debit Card as the check out methodology for iBill. This document will cover such topics as card issuance, card usage, and card loading in an effort to cause a private on-us payment scenario.
Two transactions will be provided
1. Instant Issue with credit card charge, Electron card load, and Electron Card to Web Master MID/SMID transfer.
2. Automated Load with credit card charge, Electron card load, and Electron Card to Web Master MID/SMID transfer.
   Scenario #1—Consumer does not have an Election Card

1. During check-out, if a consumer does not already have an Electron card they will be prompted to sign-up. The sign-up process will include iBill implementing a sign up HTML form that processes through their back-end into the i24Card API. It will transact using the Instant Issue message causing an instant issue of the card number and then an Immediate load and balance increase via a credit card transaction and then a subsequent value transfer from the Electron card to the Web Master MID/SMID.
2. The i24Card API Instant Issue transaction will pre-authorize the credit card, check AVS for accuracy, check OFAC for suitability, create the cardholder record, assign a card to the cardholder, activate the card number, load the initial balance for the card, post-authorize the credit card, and then finally transfer the value from the Electron Card to the Web Master MID/SMID. The response returns the Electron Card Number, Expiration Date, and CVV2/CVC2 Number that can be provided to the consumer or stored with their records.
3. The Terms and Conditions of the cardholder agreement dictate when and how a physical card will be issued, if any, and other terms such as recurring billing requirements, etc. . . .
4. iBill will store the Electron Card information relative to the consumer and cardholder data for later retrieval for subsequent check outs and recurring billing.
5. We will issue two emails branded according to Gkards. The first containing information about their purchase and load of their Electron Card. The second will be the pin/cvv2 mailer.

| | | # of | | # of |
|---|---|---|---|---|
| | Current | Emails | Going Forward | Emails |
| New | | | | |
| Signup/New | | | | |
| Card | | | | |
| One Time | *Welcome To gkard | 5 or 6 | *Welcome To gkard | 3 or 4 |
| | *gkard Transaction | | *gkard Additional | |
| | Receipt | | Information | |
| | *gkard Load Receipt | | *iBill Transaction | |
| | *gkard Additional | | Receipt | |
| | Information | | *PM Receipt | |
| | *iBill Transaction | | depending on client | |
| | Receipt | | | |
| | *PM Receipt | | | |
| | depending on client | | | |
| Recurring | *Welcome To gkard | 5 or 6 | *Welcome To gkard | 3 or 4 |
| | *gkard Transaction | | *gkard Additional | |
| | Receipt | | Information | |
| | *gkard Load Receipt | | *iBill Transaction | |
| | *gkard Additional | | Receipt | |
| | Information | | *PM Receipt | |
| | *iBill Transaction | | depending on client | |
| | Receipt | | | |
| | *PM Receipt | | | |
| | depending on client | | | |
| New | | | | |
| Signup/Existing | | | | |
| Card | | | | |
| One Time | *gkard Transaction | 3 or 4 | *gkard Transaction/ | 2 or 3 |
| | Receipt | | load Receipt | |
| | *gkard Load Receipt | | *iBill Transaction | |
| | *iBill Transaction | | Receipt | |
| | Receipt | | *PM Receipt | |
| | *PM Receipt | | depending on client | |
| | depending on client | | | |
| Recurring | *gkard Transaction | 3 or 4 | *gkard loan/trans | 2 or 3 |
| | Receipt | | *iBill Transaction | |
| | *gkard Load Receipt | | Receipt | |
| | *iBill Transaction | | *PM Receipt | |
| | Receipt | | depending on client | |
| | *PM Receipt | | | |
| | depending on client | | | |
| Rebill/Reload | *gkard Transaction | 2 | Send Nothing | 0 |
| | Receipt | | | |
| | *gkard Load Receipt | | | |
| Rebill/Instant | *Welcome To gkard | 5 | *gkard Update Billing | 2 |
| Issue | *gkard Transaction | | Info | |
| | Receipt | | *gkard Additional | |
| | *gkard Load Receipt | | Information | |
| | *gkard Additional | | | |
| | Information | | | |
| | *iBill Billing Update* | | | |

### Scenario #2—Consumer has an Electron Card

1. During check-out iBill will determine if the consumer has an Electron Card. If a consumer does, then iBill will have to present a check out form that processes through their back-end into the i24Card API. It will transact using the Automated Load/Transfer message with the option to cause an immediate load and balance increase via a credit card transaction and then a subsequent value transfer from the Electron card to the Web Master MID/SMID.
2. The i24Card API Automated Load/Transfer transaction will pre-authorize the credit card, check AVS for accuracy, compare the AVS data to that of the Electron Card for suitability, load the amount for the card, post-authorize the credit card, and then finally transfer the value from the Electron Card to the Web Master MID/SMID.
3. This will be the same transaction for recurring billing transactions.

### API Interface

### API Access

APIs refer to the ability to access certain functionality of the SYMMETREX host system by calling a defined URL and passing data through parameters. Access to the site is restricted to Secured Socket Layer (SSL).

### Message Format

The API message is sent to SYMMETREX by posting to a URL utilizing the “GET” method. Symmetrex employs the standard “GET” method for passing data to the server, thus URL encoding is used for values containing spaces, ampersands, etc. A sample URL Is listed below:

https://Symmetrexserver.com/i24Cardapi?CID=NNNN&CUSR=AAAAAAAAAAAA&
CPWD=AAAAAAAAAA&FUNC=NNN&MSGID=NNNNNNNNNN&P1=AAAAAA
AAAAAAAAAAAAAA&P2= AAAAAAAAAAAAAAAAAAAAP3=
AAAAAAAAAAAAAAAAAAAAP4=AAAAAAAAAAAAAAAAAAAA&P5=
AAAAAAAAAAAAAAAAAAAA&P6= AAAAAAAAAAAAAAAAAAAA&P7=
AAAAAAAAAAAAAAAAAAAA&P8= AAAAAAAAAAAAAAAAAAAA&P9=
AAAAAAAAAAAAAAAAAAAA&P10= AAAAAAAAAAAAAAAAAAAA

| Inputs | Description | Data Type |
|---|---|---|
| CID | Client TD | (1, 4) Numeric |
| CUSR | Client User ID | (5, 12) Varchar |
| CPWD | Client Password | (8, 20) Varchar |
| FUNC | Function ID | Numeric |
| MSGID | Message ID | Numeric |
| | | 1-5 characters reserved for |
| | | Client ID |
| | | left padded with zeros. |
| | | 6-17 characters reserved for |
| | | message id counter. |
| TABLE Continued | | |
| Outputs | Description | |
| MSGID | Message ID, echoed | |
| | back by | |
| | SYMMETREX | |
| P1 | Error Code | |

The API message definitions use the following data types. In many cases the fields are variable length and an ampersand (&) denotes the beginning of the next parameter which defines a standard URL query. The parameters for each function should be passed.

Data Types

| Data | | |
|---|---|---|
| Type | Description | Length |
| NNNNN | Numeric, only 0 | Variable, the end of the parameter is |
| | through 9 allowed | marked by either the end of the string |
| | | or the next & |
| AAAAA | Alphanumeric | Variable, the end of the parameter is |
| | | marked by either the end of the string |
| | | or the next & |

Error Codes

| Error | |
|---|---|
| Code | Description |
| 000 | Success |
| 001 | Unspecified Error |
| 002 | Login Error |
| 003 | Message ID record not found for <Message ID Number |
| | supplied by user> |
| 004 | Message ID already filed |
| 005 | Invalid Message ID Format |
| 006 | Function number is not supported |
| 007 | Invalid Client Number |
| 008 | Missing parameters (<Missing parameter listing>) |
| 009 | (Reserved for future use) |
| 010 | (Reserved for future use) |
| 011 | Invalid Card Number |
| 012 | Invalid Account Number/SSN |
| 013 | Invalid Amount |
| 014 | Invalid Transaction Type |
| 015 | Invalid Old Pin |
| 016 | Invalid New Pin |
| 017 | Invalid Start Date |
| 018 | Invalid End Date |
| 019 | The start date is earlier than the end date |
| 020 | Time date out of range |
| 021 | Invalid currency code for current BIN number |
| 022 | Host Down |
| 050 | OFAC Match Found |
| 051 | Card Acquirer Decline |

### Currency Amounts

1. Currency amounts are transmitted as integers with the resolution of the smallest available unit (e.g. cents) per currency, e.g. $10.50 is represented as 1050.
2. An ISO 4217 currency code should be specified as a parameter any time a currency amount is transmitted.
3. Error code 021 is returned if a currency is attempted against a BIN for which that BIN was not assigned that currency.

### PIN Encryption

In each message involving transmission of a PIN, the PIN value is encrypted using Triple DES algorithm in ECB mode with a shared encryption key agreed upon outside the API. The ciphertext is encoded with Base64 (RFC1341) and passed as the PIN parameter.

3DES ECB algorithm operates on 8-byte blocks. The transmitted value will be 12 characters long as a result of Base64 encoding of 8-byte ciphertext.

Function Codes

| Function | |
|---|---|
| Code | Action Description |
| 002 | Instant Issue (optional credit card charge and/or balance |
| | load and card to card transfer) |
| 003 | Card Load by Credit Card and Card to Card Transfer |

### API Messages

The following is a breakdown of Client APIs. These parameters are utilized for validation to access the system. In addition, the MSGID will be a unique counter for each transaction. The return values will be passed back to the calling routine as text with named pairs. Each value will be separated by a Carriage Return (ASCII 13) and Line Feed (ASCII 10) concatenated together. For example:

### P1=000&P2=123456789

This function provides the instant issue of a card number to a cardholder and can charge a credit card for the increase the balance of the card. If you provide an amount the balance will be loaded. If you provide credit card details, the credit card will be charged the Amount and the card subsequently loaded the same amount.

Instant Issue (with Credit Card Charge, Card Load, and Card Transfer)

| Function | | |
|---|---|---|
| ID | 002 | |
| P1 | Client Card Holder ID | (1, 9) Numeric |
| P2 | First Name | (1, 20) Varchar |
| P3 | Middle Initial | (1, 1) Varchar |
| P4 | Last Name | (1, 20) Varchar |
| P5 | Address1 | (1, 30) Varchar |
| P6 | Address2 | (1, 30) Varchar |
| P7 | City | (1, 25) Varchar |
| P8 | State | (1, 8) Varchar |
| P9 | Zip Code | (5, 9) Varchar |
| P10 | Country Code (ISO 3166) | (2) Varchar Alpha |
| P11 | UDF1 | (255) Varchar |
| P12 | UDF2 | (255) Varchar |
| P13 | UDF3 | (255) Varchar |
| P14 | UDF4 | (255) Varchar |
| P15 | UDF5 | (255) Varchar |
| P16 | Email | (1, 40) Varchar |
| P17 | Load Amount - Represents the | Numeric (See 1.1.5) |
| | amount of money on the initial load | |
| | when assigning the card number | |
| P18 | Credit Card - Card number to charge | (1, 26) Numeric |
| | for the Amount (P19) if a load is | |
| | required | |
| P19 | Credit Card Expiry Date - | (1, 4) Numeric |
| | Expiration date of the credit card. | |
| | MMYY | |
| P20 | CVD - Cardholder Verification Data | (1, 3) Numeric |
| | (CVV2, CVC2) | |
| P21 | Transfer Amount - Amount to | (1, 9) Varchar |
| | transfer from Electron Card to Web | |
| | Master | |
| P22 | Web Master VID | (1, 20) Varchar |
| P23 | Cardholder IP Address | (1, 15) Varchar |
| P24 | RSID - Reseller/Referrer ID | |
| P25 | Merchant Descriptor 1 | |
| P26 | Merchant Descriptor 2 | |
| P27 | Transaction Description | |
| P28 | iBill Transaction Tracking ID | |
| P29 | RecurID | 0 = not recurring |
| | | 1 = recurring |
| | | transaction |
| P30 | DOB | Date (i.e., |
| | | mm/dd/yyyy |
| | | or m/d/yyyy) |
| P31 | Phone | (7, 15) Varchar |
| P32 | Not Used | |
| P33 | Security Field 1 can include mother's | (1, 22) Varchar |
| | maiden name or license number | |
| P34 | Security Field 1 can include mother's | (1, 22) Varchar |
| | maiden name or license number | |
| P35 | Not Used | |
| P36 | User defined field. It handles special | (1, 16) Varchar |
| | requirements for the client | |
| P37 | User defined field. It handles special | (1, 16) Varchar |
| | requirements for the client | |
| P38 | Social Security Nbr. | (1, 9) Varchar |
| P39 | Embossing Data - used for | (1, 40) Varchar |
| | embossing the name of the company | |
| | on the card | |
| P1 | Error Code | |
| P2 | Error Text | |
| P3 | Electron Card Number - Instant | |
| | issue card number | |
| P4 | Electron Expiration Date | |
| P5 | Electron CVV2/CVC2 Number | |
| P6 | Credit Card Auth Number | |
| P7 | Credit Card Ref Number | |
| P8 | Credit Card Transaction Id | |
| P9 | Available Balance - Electron Card | |
| P10 | Ledger Balance - Electron Card | |
| P11 | Load Amount | |
| P12 | Transfer Amount | |

Note: OFAC check function (‘056’) may be optionally executed for this function. If you are configured for Automated OFAC Checking, then any create card request will automatically check OFAC. If an OFAC Match is found, the Create Card Holder request will not be processed.

Automated Load (with credit card charge, card load, and card transfer)

| Function | | |
|---|---|---|
| ID | 002 | |
| P1 | Electron Card | (1, 16) Numeric |
| P2 | First Name | (1, 20) Varchar |
| P3 | Middle Initial | (1, 1) Varchar |
| P4 | Last Name | (1, 20) Varchar |
| P5 | Address1 | (1, 30) Varchar |
| P6 | Address2 | (1, 30) Varchar |
| P7 | City | (1, 25) Varchar |
| P8 | State | (1, 8) Varchar |
| P9 | Zip Code | (5, 9) Varchar |
| P10 | Country Code (ISO 3166) | (2) Varchar Alpha |
| P11 | UDF1 | (255) Varchar |
| P12 | UDF2 | (255) Varchar |
| P13 | UDF3 | (255) Varchar |
| P14 | UDF4 | (255) Varchar |
| P15 | UDF5 | (255) Varchar |
| P16 | Email | (1, 40) Varchar |
| P17 | Load Amount - Represents the | Numeric (See 1.1.5) |
| | amount of money on the initial load | |
| | when assigning the card number | |
| P18 | Credit Card - Card number to | (1, 26) Numeric |
| | charge for the Amount (P19) if a | |
| | load is required | |
| P19 | Credit Card Expiry Date - | (1, 4) Numeric |
| | Expiration date of the credit card. | |
| | MMYY | |
| P20 | CVD - Cardholder Verification | (1, 3) Numeric |
| | Data (CVV2, CVC2) | |
| P21 | Transfer Amount - Amount to | (1, 9) Varchar |
| | transfer from Electron Card to Web | |
| | Master | |
| P22 | Web Master VID | (1, 20) Varchar |
| P23 | Cardholder IP Address | (1, 15) Varchar |
| P24 | RSID - Reseller/Referrer ID | |
| P25 | Merchant Descriptor 1 | |
| P26 | Merchant Descriptor 2 | |
| P27 | Transaction Description | |
| P28 | iBill Transaction Tracking ID | |
| P29 | RecurID | 0 = not recurring |
| | | 1 = recurring |
| | | transaction |
| P1 | Error Code | |
| P2 | Error Text | |
| P3 | Electron Card Number - Instant | |
| | issue card number | |
| P4 | Electron Expiration Date | |
| P5 | Electron CVV2/CVC2 Number | |
| P6 | Credit Card Auth Number | |
| P7 | Credit Card Ref Number | |
| P8 | Credit Card Transaction Id | |
| P9 | Available Balance - Electron Card | |
| P10 | Ledger Balance - Electron Card | |
| P11 | Load Amount | |
| P12 | Transfer Amount | |

### Credits

1. Credits will be handled according to the existing i24Gateway SecureCharge API.

### Merchant Settlement

1. Since each of these Proprietary Merchant Ids exist on our system and are in effect really nothing more than card numbers (either Visa or Private). The money remains in the funding account until settlement to the merchants. The existing settlement systems and eventually the new i24FeePay versions will still be able to settle.
2. As well, when iBill is ready to issue Merchant Visa Electron Cards that actually work at ATM/POS, i24FeePay will be able to settle from the Propriety Merchant Ids (really just card numbers) to the actual physical Merchant Electron Card via the i24Card API Card to Card Transfer.

### Reseller and Referrer Settlement

1. Since each of these transactions is accompanied with the lowest level of the referral chain and settlement based lookup takes place, we will not lose the ability to settle to referrers.
2. As well, the settlement to the referrers could be a subset of Merchant Electron Card settlement where they are just another set of cardholders, be they consumer cardholders, merchant cardholders, or referrer cardholders. In the end, an entity is a cardholder that equates to an account holder.

### Summary

An effect is that a Card Association Merchant Account will load the cards by debiting traditional credit cards. In an embodiment, during check out, the consumer will use these Visa Electron card numbers, that were issued in real-time, to purchase products and services from merchants that are other cardholders, and thus the transaction that takes place is off network, on-us, private account holder to account holder transfer of funds.

There are also a few card holder/admin reporting areas we feel should be utilized by iBill for the Electron Card holders . . .

### IVR-Debysis

### CHP-Consumer Card Holder Portal

### CMS-Card Management System

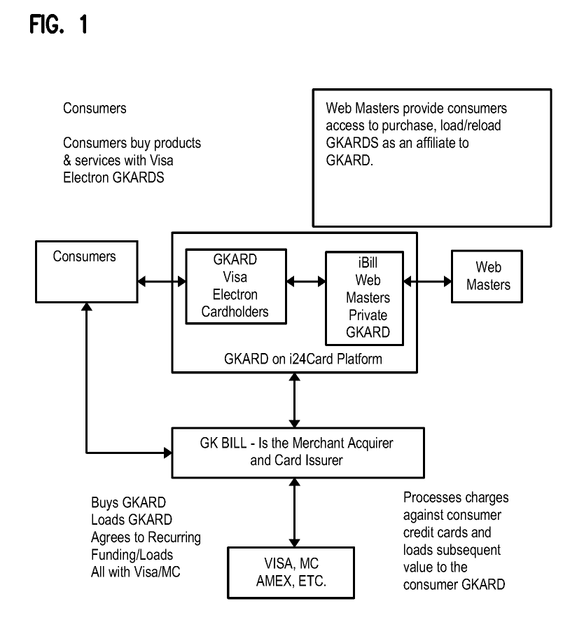

FIG. 1 shows an example process for consumers to buy products and services with GKARDS.

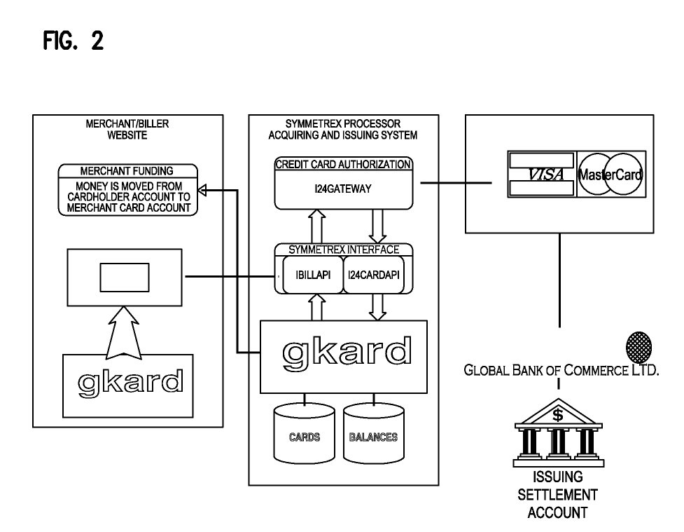

FIG. 2 shows an example process for GKARD purchase and load.

### Converted Rebill/Instant Issue

### To: $P16 (Customer Email Address)

From: CustomerService@ gkbill.com
Subject: gkard Transaction Information

### $P2 (First Name) $P4 (Last Name)

### $P5 (Address 1)

### $P6 (Address 2)

### $P7 (City), $P8 (State) $P9 (Zip)

### $P10 (Country)

### Dear (Merchant Descriptor 2) Subscriber:

Welcome to gkard, the international VISA pre paid card from gkbill. You will be able to purchase products and services from a wide variety of merchants and web sites with your gkard. Your gkard is a virtual VISA Electronic Card that can and will be loaded with value from your existing credit cards. This allows you to purchase goods and services in a more secure, trusted, and anonymous fashion than normal methods.

Whenever you use or load value on your gkard, you will see a charge on your credit card statement for GKBill.com. At www.gkbill.com you can view your transaction history, obtain balance information and your statement summary.

For additional information regarding this transaction, please visit https://www.gkbill.com.

### GKard Account Details

### GKard Number: 4213587000000845

### Expiration Date: 0610

For security reasons, you will be receiving a separate email containing additional information. You will use this information to access your gkard account details and activity at https://www.gkbill.com.

### Associated Credit Card Details

### Credit Card: 4**********59823

### Expiration Date: 0806

No additional changes to your existing subscription have been made and you will not experience any service interruptions.
Thank You for using gkard,

### Gkard Customer Service

Customerservice@ gkbill.com
https://www.gkbill.com

### To: $P16 (Customer Email Address)

From: CustomerService@ gkbill.com
Subject: Additional gkard Details

### $P2 (First Name) $P4 (Last Name)

### $P5 (Address 1)

### $P6 (Address 2)

### $P7 (City), $P8 (State) $P9 (Zip)

### $P10 (Country)

### Dear $P2 (First Name),

Below you will find additional details about your gkard virtual VISA Electronic Card. You can use this information in conjunction with your gkard account which you received in a separate email to access your account details, view transaction history and change your temporary pin by visiting https://www.gkbill.com.
Additional gkard Account Details

### PIN: 0000

### CVV2:541

### Thank You,

gkard Customer Service
customerservice@ gkbill.com
www.gkbill.com

### Converted Rebill/Instant Issue

### To: $P16 (Customer Email Address)

From: CustomerService@ gkbill.com

### Subject: Billing Update

### $P2 (First Name) $P4 (Last Name)

### $P5 (Address 1)

### $P6 (Address 2)

### $P7 (City), $P8 (State) $P9 (Zip)

### $P10 (Country)

### Dear (Merchant Descriptor 2) Subscriber:

The purpose of this e-mail is to inform you of an important billing change. Previously, your credit card has been charged with the descriptor ibillcs.com for your subscription to (Merchant Descriptor 2). Going forward, gkbill will now be the new billing agent. Your next credit card statement will contain the new billing agent descriptor, gkard load*gkbill.com for this subscription.

By switching billing agents, your last rebill may have been slightly delayed. As result of bringing your account up to date, you might see two charges on your next credit card statement to coincide with the delayed and current charge.

In order to continue your current membership to (Merchant Descriptor 2), you have been issued a gkard virtual VISA Electronic Card. This virtual account has been funded $P17 (Load Amount) from your credit card associated with this subscription. The virtual account then pays for the recurring subscription fee.

For additional information regarding this transaction, please visit https://www.gkbill.com.

### GKard Account Details

### GKard Number: 4213587000000845

### Expiration Date: 0610

For security reasons, you will be receiving a separate email containing additional information. You will need this information to access your gkard account details and activity at https://www.gkbill.com.

### Associated Credit Card Details

### Credit Card: 4**********59823

### Expiration Date: 0806

No additional changes to your existing subscription have been made and you will not experience any service interruptions.

Thank You for using gkard,

### Gkard Customer Service

Customerservice@ gkbill.com
https://www.gkbill.com

### To: $P16 (Customer Email Address)

From: CustomerService@ gkbill.com
Subject: Additional gkard Details

### $P2 (First Name) $P4 (Last Name)

### $P5 (Address 1)

### $P6 (Address 2)

$P7 (City), $P8 (state) $P9 (Zip)

### $P10 (Country)

### Dear $P2 (First Name),

Below you will find additional details about your gkard virtual VISA Electronic Card. You can use this information in conjunction with your gkard account which you received in a separate email to access your account details, view transaction history and change your temporary pin by visiting https://www.gkbill.com.

Additional gkard Account Details

### PIN: 0000

### CVV2:541

### Thank You,

gkard Customer Service
customerservice@ gkbill.com
www.gkbill.com

### Phase 3.0

The following has been identified for next phase of the Prepaid debit gKard Electron product.
Redevelopment of the gkbill.com website.
   Addition of the “LOAD FUNDS”
   Addition of the “SEND FUNDS”
   Addition of the “REQUEST FUNDS”
   Addition of the “SIGNUP”
The generation of e-mail accounts for gKard card members.
   Addition of a e-mail address
   Addition of a broadcast service
   Addition of mail alerts on the www.gkbill.com website
“Identify Protection”
Additional card programs along with additional branding. We also have to begin to look at “how” we brand the card, so that gKard name is not used but instead the brand like “PENTHOUSE”, etc.
Cardholder benefits:

### Main Menu Options:

1. Cardholder Services
   1. Balance Inquiry
   2. PIN Change
   3. Card-to-card transfer
   4. Get Direct Deposit number
   5. Load from Bank Account (Future)
   6. Transaction details (Future)
   0. Operator Services—
   Opportunity to charge the Cardholder built In to functions above Individually. Some items you may prefer not to charge for such as a Balance Inquiry. Some you may want to charge for such as Card-to-Card transfers.

2. Make a Long Distance Call
Customer LD balance is checked. If greater than $0.50 allows a call to start.
If less than $0.50 prompt customer to add funds to the LD balance
Place a call (IVR call in rates stop and LD rates begin)
Customer can press ## at any time to stop the current call and begin another.
Note: Customer do not enter any additional information—there is no separate account number or PIN number to remember.
Cardholder is charged the LD rate deck shown on this spreadsheet.
Opportunity to charge an additional surcharge to the customer here.
Program is given 20% of the amount loaded to the LD fee.

### IVR Call Flow Cont'd

3. Recharge your Prepaid Cellular Phone
1. AT&T
2. Boost Mobile
3. Cingular
4. T-Mobile
5. Verizen
6. Tracfone
7. Alitel
8. Call Plus
9. Airvoice
   Each provider above has various denominations of PINs which from which the customer is prompted to select. Once the value is selected and confirmed the card is charged and the PIN is read to the customer. He can read it as many times as is required to be properly written down.
   Instructions for PIN use are also provided and can be repeated.
Cardholder is charged the retail rate of the PIN.
Opportunity to charge an additional surcharge to the customer here.
Program is given the difference between the retail price less the cost and the PIN products handling fee.

4. Pay a Bill
Customer is prompted to accept the fee for a bill payment
Bill payment charges will be explained by the Bill Pay Service Center.
Fee from $3 to $4.
Call is currently forwarded to customer service where the card is charged (using CMS), the bill information is entered into a web based system for electronic payment.
Note: This method is very expensive. In the future we will automate this bill payment system to better service the customers.

5. Get a payday advance.
Customer is given basic Information on the Payday advance.
The call is forwarded to our Payday loan partner.
If the customer qualifies the loan is loaded on their card and the program receives $10 of the processing fee. (Net back to the program should be between $5 and $6 depending on loan size. This is paid back monthly.)

6. Directory Assistance Services
Opportunity to set the amount of the DA call charged to the customer here.
Phone lookup, directions, movie locations and showtimes, horoscopes. flight times, sport scores, time, weather, restaurant, email on the go, etc. . . .

7. Healthcare (coming soon)
Health (medical and dental)

8. Purchase other prepaid products and services (coming soon)
Legal
Internet
Roadside Assistance

0. Customer Service
Opportunity to charge the Cardholder built in before handing off to a live operator.
Call transferred to the card program customer service center.

Billing Element Table (BET)
CLIENT:
BIN #:
PROGRAM NAME:

| 1 | Card Activation Fee | $0.00 | $0.00 |
|---|---|---|---|
| 2 | Monthly Service Charge | $0.00 | |
| | ATM TRANSACTIONS | | |
| 3 | ATM Domestic Withdrawals | $0.00 | $0.00 |
| 4 | ATM International Withdrawals | $0.00 | $0.00 |
| 5 | ATM Domestic Balance Inquiry | $0.00 | |
| 6 | ATM International Balance Inquiry | $0.00 | |
| 7 | ATM Unknown Transaction | $0.00 | $0.00 |
| | POS TRANSACTIONS | | |
| 8 | POS Domestic Purchase | $0.00 | $0.00 |
| 9 | POS International Purchase | $0.00 | $0.00 |
| 10 | POS Pre-Auth Domestic Purchase | $0.00 | $0.00 |
| 11 | POS Pre-Auth International Purchase | $0.00 | $0.00 |
| 12 | POS Merchandise Return - Domestic | $0.00 | $0.00 |
| 13 | POS Merchandise Return - International | $0.00 | $0.00 |
| 14 | POS Domestic Balance Inquiry | $0.00 | |
| 15 | POS International Balance Inquiry | $0.00 | |
| 16 | POS Unknown Transaction | $0.00 | $0.00 |
| 17 | POS Purchase w/ Cash Back - Domestic | $0.00 | $0.00 |
| 18 | POS Purchase w/ Cash Back - International | $0.00 | $0.00 |
| | MISC TRANSACTIONS | | |
| 19 | PIN Change - Internet | $0.00 | |
| 20 | PIN Change - Cust Svc | $0.00 | |
| 21 | Card Cash Out - Portal | $0.00 | |
| 22 | Change Card Status | $0.00 | |
| 23 | Card Load (Credit) - API | $0.00 | |
| 24 | Card Unload (Debit) - API | $0.00 | |
| 25 | Card to Card Transfer-Internet | $0.00 | |
| | LOADING TRANSACTIONS | | |
| (OPTION 1) Value Load/Reload Transaction - | | $0.00 | $0.00 |
| Retail | | | |
| (OPTION 2) Bill Payment Load | | $0.00 | $0.00 |
| (OPTION 3) Direct Deposit Load | | $0.00 | $0.00 |
| (OPTION 4) Internet Credit Card Load | | $0.00 | $0.00 |
| (OPTION 5) Bank Deposit Load (Manual) | | $0.00 | $0.00 |
| (OPTION 6) Value Load/Reload Transaction - | | $0.00 | $0.00 |
| ACH | | | |
| (OPTION 7) POS Cardholder Load (Symmetrex) | | $0.00 | $0.00 |
| | IVR TRANSACTIONS | | |
| 26 | Entry charge after successful account | $0.00 | |
| | verification | | |
| 27 | Payphone surcharge if call originates from | $0.00 | |
| | payphone | | |
| 28 | Balance Inquiry Charge | $0.00 | |
| 29 | PIN Change Charge | $0.00 | |
| 30 | Card-to-Card Transfer Charge | $0.00 | |
| 31 | Get Federal Deposit Information Charge | $0.00 | |
| 32 | Load from Bank Account Charge | $0.00 | |
| 33 | Transaction Details Charge | $0.00 | |
| 34 | Transfer to Live Customer Service Charge | $0.00 | |
| 35 | Charge for accessing Bill Payment Service | $0.00 | |
| 36 | Charge for accessing Directory Assistance | $0.00 | |
| 37 | Charge for accessing Payday Advance | $0.00 | |
| | ADMINISTRATIVE TRANSACTIONS | | |
| 38 | Chargeback Fee | $0.00 | |
| 39 | Representment Fee | $0.00 | |
| 40 | Lost/Stolen Replacement Card | $0.00 | |
| 41 | Load from Credit Card [MDR] Rate | $0.00 | |
| | Percentage | | |

Signature

Date

We claim:

1. A method comprising:
issuing, at a virtual credit card issuer, a virtual credit card to an entity;
debiting a monetary amount from a credit card account associated with a credit card issued by a financial institution that has extended credit to the entity;
crediting the monetary amount to a virtual credit card account associated with the virtual credit card;
receiving, at the virtual credit card issuer, a request for payment directly from a merchant who accepted a credit card number of the virtual credit card as a form of payment from the entity; and
honoring the request for payment when a monetary amount specified by the request for payment is less than or equal to the monetary amount credited to the virtual credit card account associated with the virtual credit card.
